(19) United States
(12) Patent Application Publication
(10) Pub. No.: US 2008/0083324 A1
(43) Pub. Date: Apr. 10, 2008

(54) Adjustment element with a cylinder

(75) Inventors: Stefan Ackermann, Bonn (DE); Arnold Schilz, Lahnstein (DE); Stefan Burg, Ettringen (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/904,532

(22) Filed: Sep. 27, 2007

(30) Foreign Application Priority Data
Sep. 28, 2006 (DE) 10 2006 046 338.2
Feb. 14, 2007 (DE) 10 2007 007 273.4

(51) Int. Cl. F15B 20/00; F15B 15/14; F16F 9/02; F16F 9/36; F16J 10/02; F16J 15/56

(52) U.S. Cl. 92/1; 267/129

(57) ABSTRACT

An adjustment element includes a cylinder; a piston axially movable in the cylinder and having a piston rod; an elastic annular seal between the piston and the one end of the cylinder, the annual seal including inner and outer radially circumferences which sealingly bear against the piston rod and the cylinder, respectively; a ring-shaped supporting element which is between the one end of the cylinder and the annular seal and axially supported by the cylinder, there being at least one of a first annular gap between the supporting element and the piston rod and a second annular gap between the supporting element and the cylinder; and a safety element which fills in the at least one of the first and second annular gaps. The safety element is made of a material with low melting temperature. The annular seal is axially supported by the supporting element and the safety element.

### BACKGROUND OF THE INVENTION

1. Field of the Invention

The invention relates to an adjustment element with a cylinder, the inner space of which contains a medium which is under pressure, with a piston which is arranged displaceably in the cylinder and has a piston rod which projects out of the cylinder at one end of the cylinder, with an annular seal which surrounds the piston rod and consists of an elastic material and which is in sealing bearing contact with its inner radially continuous circumference against the piston rod and with its outer radially continuous circumference against the inner wall of the cylinder, is acted upon on its side facing the inner space by the pressure of the medium and is supported with its side facing away from the inner space on a ring-like supporting element which surrounds the piston rod and which, in turn, is supported with its end facing away from the annular seal against a part of the cylinder, and with a safety element which is designed to vary its shape in the event of thermal overloading, with the result that a passage orifice from the inner space of the cylinder to the surroundings can be formed.

2. Description of the Related Art

In adjustment elements of this type, which are preferably pneumatic springs, the inner space filled with the medium must be connectable to the surroundings in the event of an overshooting of a specific internal pressure in the cylinder, in order to avoid too high an internal pressure in the cylinder. Too high an internal pressure, which may occur, for example, in the event of a fire in the surroundings of the adjustment element or due to a temperature rise or else by deformation, may lead to a destruction of the cylinder or to the piston rod being pressed out of the cylinder.

Pneumatic springs of this type may be, for example, pneumatic adjustment elements for easy handling for the boot lid, the tailgate or the bonnet of a motor vehicle, the said adjustment elements providing compensation for the weight of the parts to be adjusted.

### SUMMARY OF THE INVENTION

An object of the invention is to provide an adjustment element of the type mentioned above, which, in the event of a temperature increase and the associated pressure rise in the inner space of the cylinder beyond a specific internal pressure, leads to a reliable pressure relief of the inner space, and which is constructed with few simple components.

This object is achieved, according to the invention, in that the safety element is arranged, sleeve-like, in an annular gap between the piston rod and the supporting element and/or in an annular gap between the supporting element and the inner wall of the cylinder and consists of a melting or sublimating material or of a thermal plastic, the radially inner region and/or the radially outer region of the annular seal being supported on the safety element.

The supporting element normally serves, together with the safety element, for fixing and axially supporting the annular seal. In the event of an overshooting of a specific temperature and of a concomitant rise in the internal pressure of the cylinder beyond a specific internal pressure, the supporting element melts or sublimates or flows in the annular gap, so that there is no axial support of the annular seal in the region of the safety element. The elastic material of the annular seal is deformed, due to the pressure in the inner space of the cylinder, into the annular gap between the piston rod and the supporting element and/or into the annular gap between the supporting element and the inner wall of the cylinder. As a result, the annular seal no longer bears sealingly against the piston rod and/or against the inner wall of the cylinder, so that the medium can flow past the annular seal through the annular gap outwards.

In addition, the annular seal may be supported axially on the supporting element via a radial annular part of the safety element which annular part extends completely or partially over that end face of the supporting element which faces the inner space of the cylinder.

A strength of the safety element which is sufficient for the supporting function, along with a safety function sufficient in the event of thermal overloading, is achieved when the safety element consists of a metal or of a metal alloy having a low melting temperature. In particular, zinc, zinc die-casting or fine zinc alloys have proved to be advantageous.

If the annular seal has an inner sealing lip bearing against the piston rod and/or an outer sealing lip bearing against the inner wall of the cylinder, then, although the sealing lips are flexible for good sealing-off and for deformation into the annular gap, the base of the annular seal nevertheless remains stable.

In this case, the outer sealing lip and/or the inner sealing lip may be directed axially towards the inner space of the cylinder.

So that the base of the annular seal is dimensionally stable in a reliable way, even though the elastic material of the annular seal is largely flexible, the annular seal may have a stabilizing ring consisting of a material of lower flexibility than the material of the annular seal, the said stabilizing ring lying axially opposite the annular end face of the supporting element.

For the stability of the base of the annular seal, the stabilizing ring preferably comprises a rigid material, such as metal, in particular of steel, or else even of a hard plastic.

For the possibility of easy production, the reinforcing ring may be a reinforcing ring insertable into a corresponding recess of the annular seal.

A considerable reduction in the components and therefore in the outlay in terms of assembly arises in that the stabilizing ring is produced in one piece with the radial annular part of the safety element. This component consequently also consists completely of a metal or of a metal alloy having a low melting temperature.

It makes assembly even easier when the stabilizing ring is vulcanized into the recess of the annular seal.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are illustrated in the drawing and are described in more detail below. In the drawing:

FIG. 1 shows an enlarged detail of a first exemplary embodiment of an adjustment element in the normal state,

FIG. 2 shows the enlarged detail according to FIG. 1 in the overheating state,

FIG. 3 shows an enlarged detail of a second exemplary embodiment of an adjustment element in the normal state,

FIG. 4 shows an enlarged detail of a third exemplary embodiment of an adjustment element in the normal state.

### DETAILED DESCRIPTION OF THE PRESENTLY PREFERRED EMBODIMENTS

The adjustment elements illustrated possess a tube-like cylinder 1, the wall of which is flanged at one end of the cylinder 1 to form an end wall 2. A continuous passage orifice 3 is formed in the end wall 2 coaxially to the longitudinal extent of the cylinder 1.

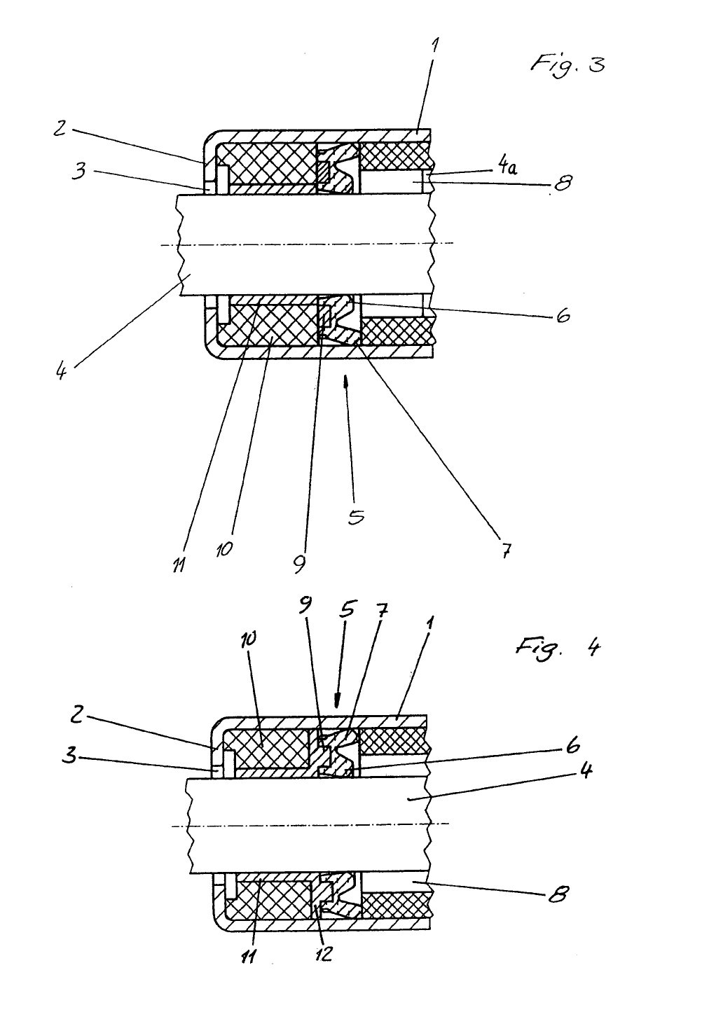

A piston 4a (see FIG. 3) is arranged axially displaceably in the cylinder 1 and possesses a piston rod 4 which projects outwards through the passage orifice 3.

The piston rod 4 is surrounded by an annular seal 5 which is in bearing contact with its radially continuous inner sealing lip 6 against the piston rod 4 and with its radially continuous outer sealing lip 7 against the inner wall of the cylinder 1.

The sealing lips 6 and 7 are arranged on that side of the annular seal 5 which faces the inner space 8 of the cylinder 1 and are acted upon against the piston rod 4 and against the inner wall of the cylinder 1 respectively by a gas under pressure which is located in the inner space 8.

To stabilize the annular seal 5, the latter possesses a stabilizing ring 9 which is inserted on that side of the said annular seal which faces away from the inner space 8 into an annular recess and which consists of a material of low flexibility, in particular of steel.

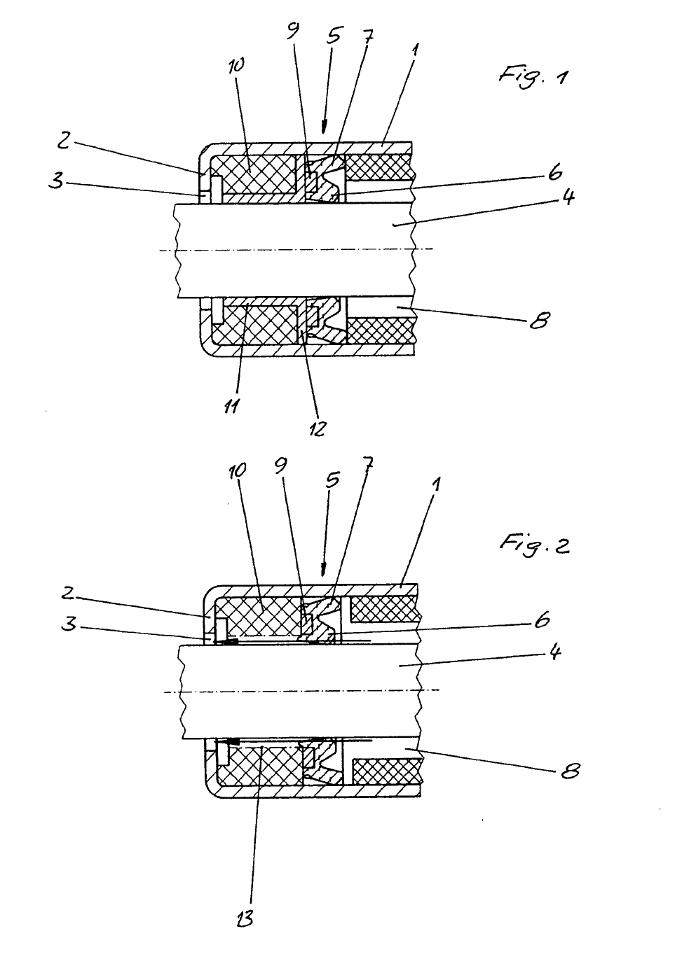

The annular seal 5 acted upon by the gas pressure is supported with its annular face facing away from the inner space axially on an annular supporting element 10 via an annular part 12 in FIGS. 1, 2 and 4 and directly in FIG. 3. This supporting element 10 is in bearing contact with its radially continuous surface area against the inner wall of the cylinder 1 and is supported axially with its end face facing the end wall 2 against the end wall 2.

Between the supporting element 10 and the piston rod 4, an annular gap 13 is present, which is filled by a sleeve-like safety element 11 which is produced in one piece with the annular part 12 in FIGS. 1 and 2. In FIG. 3, the sleeve-like safety element 11 possesses no annular part. In this case, the inner sealing lip 6 is supported on the end face against the sleeve-like safety element 11.

The sleeve-like safety element 11 and the annular part 12 consist of a material which melts in the event of thermal overloading.

This also applies to the exemplary embodiment of FIG. 4 in which the safety element 11, the annular part 12 and the stabilizing ring 9 are produced in one piece, the stabilizing ring 9 being vulcanized into the recess of the annular seal 5.

Normally, as illustrated in FIGS. 1 and 3, the pressure in the inner space 8 of the cylinder 1 is below a specific pressure and the adjustment element functions as intended.

In the event of a thermal overloading of the adjustment element, the safety element 11 and the annular part 12 melt as a result of the action of heat, and their material runs away outwards.

As a result, the annular gap 13 opens and the elastic material of the inner sealing lip 6 of the annular seal 5 is pressed into the annular gap 13 by the pressure in the inner space of the cylinder 1.

On account of this, however, the inner sealing lip no longer bears sealingly against the piston rod 4, so that the gas located in the inner space 8 of the cylinder 1 can, so as to reduce pressure, flow between the inner sealing lip 6 and the piston rod 4 and outwards through the annular gap 13 (see FIG. 2).

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An adjustment element comprising:
a cylinder having one end and defining an inner space containing a pressurized medium;
a piston axially movable in the cylinder, the piston comprising a piston rod which extends through the one end of the cylinder;
an elastic annular seal disposed in the cylinder and between the piston and the one end of the cylinder, the annual seal comprising an inner radially continuous circumference which sealingly bears against the piston rod and an outer radially continuous circumference which sealingly bears against the cylinder, wherein the pressurized medium acts on a side of the annular seal facing the inner space;
a ring-shaped supporting element axially supporting the annular seal relative to the cylinder and disposed in the cylinder between the one end of the cylinder and the annular seal, at least one of a first annular gap between the supporting element and the piston rod and a second annular gap between the supporting element and the cylinder; and
a safety element comprising a sleeve-shaped part arranged in the at least one of the first annular gap and the second annular gap, the safety element comprising a melting or sublimating material or a thermal plastic,
wherein at least one of a radially inner region and a radially outer region of the annular seal is axially supported on the safety element, and
wherein the safety element deforms when the pressurized medium reaches a pre-determined temperature such that a pressure release passage orifice is created from the inner space of the cylinder to outside of the cylinder, whereby pressure medium can flow outward through the pressure release passage orifice.

2. The adjustment element of claim 1, wherein the safety element further comprises a radial annular part which is disposed between the support element and the annular seal.

3. The adjustment element of claim 1, wherein the melting or sublimating material comprises a metal or a metal alloy having a melting temperature which is at or lower than the pre-determined temperature.

4. The adjustment element of claim 3, wherein the metal or the metal alloy comprises zinc, zinc die-casting or a fine zinc alloy.

5. The adjustment element of claim 1, wherein the annular seal further comprises an inner sealing lip which sealingly bears against the piston rod and an outer sealing lip which sealingly bears against the cylinder, the inner and outer sealing lips facing the inner space of the cylinder.

6. The adjustment element of claim 1, further comprising a stabilizing ring which is less flexible than the annular seal and disposed between the supporting element and the annular seal.

7. The adjustment element of claim 6, wherein the stabilizing ring comprises a metal material.

8. The adjustment element of claim 6, wherein the annular seal has a recess, the stabilizing ring being insertable into the recess of the annular seal.

9. The adjustment element of claim 8, wherein the safety element further comprises a radial annular part which is disposed between the support element and the annular seal, the stabilizing ring being integrally formed with the radial annular part.

10. The adjustment element of claim 8, wherein the stabilizing ring is vulcanized into the recess of the radial annular part.
